(19) United States
(12) Patent Application Publication
(10) Pub. No.: US 2016/0001785 A1
(43) Pub. Date: Jan. 7, 2016

(54) MOTION SENSING SYSTEM AND METHOD

(71) Applicant: Chin-Jung Hsu, New Taipei City (TW)

(72) Inventor: Chin-Jung Hsu, New Taipei City (TW)

(21) Appl. No.: 14/324,242

(22) Filed: Jul. 7, 2014

(51) Int. Cl. B60W 50/10

(52) U.S. Cl. CPC B60W 50/10

(57) ABSTRACT

The motion sensing system contains an application module installed in an information device, a control device in the automobile data-linked to the application module, an assistance subsystem data-linked to the control device and providing interaction with a driver of the automobile on behalf of the control device, and a motion sensing device data-linked to the control device and providing control to automobile and the information device through the control device by hand gestures performed by the driver. The motion sensing device contains a gesture definition module allowing the driver to define hand gestures by himself or herself. The driver then can wave his/her hand and make gestures within a coverage area by the motion sensing device to operate the automobile or the information device with little distraction to the traffic condition ahead

### BACKGROUND OF INVENTION

(a) Technical Field of the Invention

The present invention is generally related to motion sensing, and more particular to a motion sensing system for an automobile and a related method.

(b) Description of the Prior Art

When driving an automobile, a driver has to concentrate on his or her operation of the automobile such as the manipulation of the handle, the exercising of the accelerator, etc. so as to control the automobile's direction and speed. However, modem automobiles have various appliances equipped for enhancing the driving experience such as stereo, air conditioner, navigation system, etc. The driver is therefore easily distracted.

For safety's sake, it would be best to stop the automobile before operating these appliances. But this is not always possible, for example, when the automobile is running on a highway. As such, automobile accidents due to driver distraction are not uncommon.

Also for safety's sake, the driver should not answer or make phone calls while driving. Even though the driver can use a hands-free earphone, the driver still has to free one hand (e.g., to press a button) and divert some of his/her attention. Risk of causing traffic accident is still high during the process.

### SUMMARY OF THE INVENTION

A motion sensing system and a related method for an automobile are provided. According to the present invention, an application module in an information device, and a control device, a motion sensing device, and an assistance subsystem in the automobile are provided. Then, the application module is data-linked with the control device. Hand gestures corresponding to control functions of the automobile and the information device using the motion sensing device are defined. Then, the hand gestures of a driver of the automobile are detected, and the corresponding control functions are performed through the control device and the application module on the automobile and the information device, respectively.

The motion sensing system contains an application module installed in an information device, a control device in the automobile data-linked to the application module, an assistance subsystem data-linked to the control device and providing interaction with a driver of the automobile on behalf of the control device, and a motion sensing device data-linked to the control device and providing control to automobile and the information device through the control device by hand gestures performed by the driver.

The motion sensing device contains a gesture definition module allowing the driver to define hand gestures. The driver can define a number of hand gestures by himself or herself using the motion sensing device and the gesture definition module. The driver then can wave his/her hand and make gestures within a coverage area by the motion sensing device to operate the automobile or the information device with little distraction to the traffic condition ahead.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a motion sensing system according to an embodiment of the present invention. FIG. 2 is a perspective diagram showing the motion sensing system of FIG. 1.

FIG. 3 shows a first scenario of using the motion sensing system of FIG. 1.

FIG. 4 shows a second scenario of using the motion sensing system of FIG. 1.

FIG. 5 shows a third scenario of using the motion sensing system of FIG. 1.

FIG. 6 shows a fourth scenario of using the motion sensing system of FIG. 1.

FIG. 7 shows a fifth scenario of using the motion sensing system of FIG. 1.

FIG. 8 shows a sixth scenario of using the motion sensing system of FIG. 1.

FIG. 9 shows a seventh scenario of using the motion sensing system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

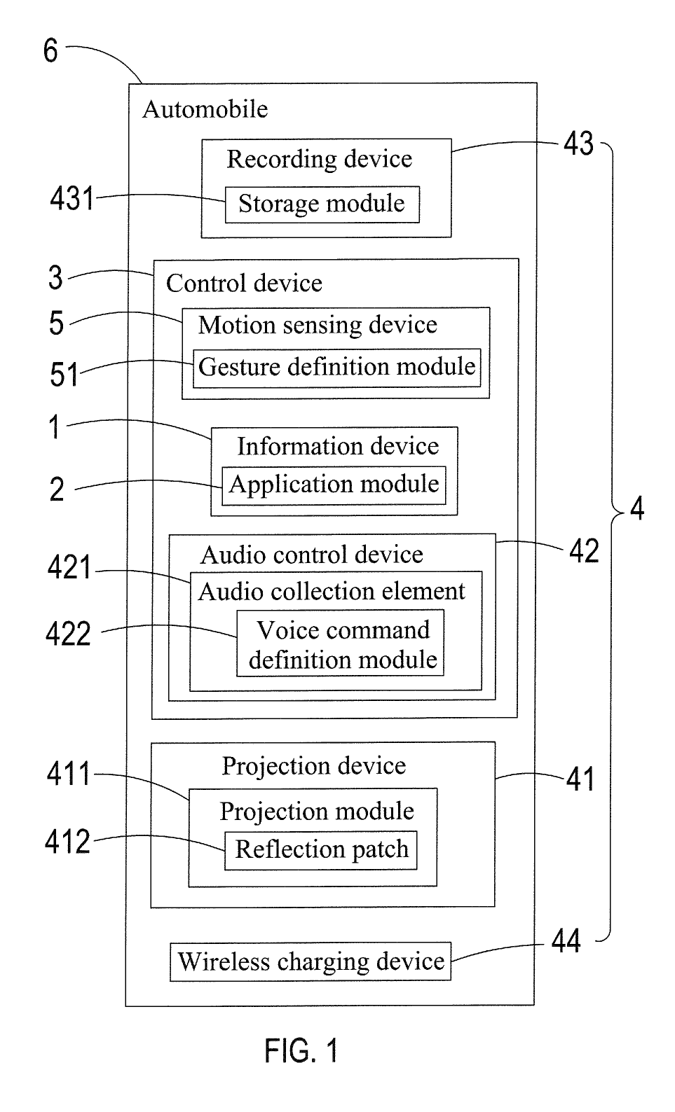

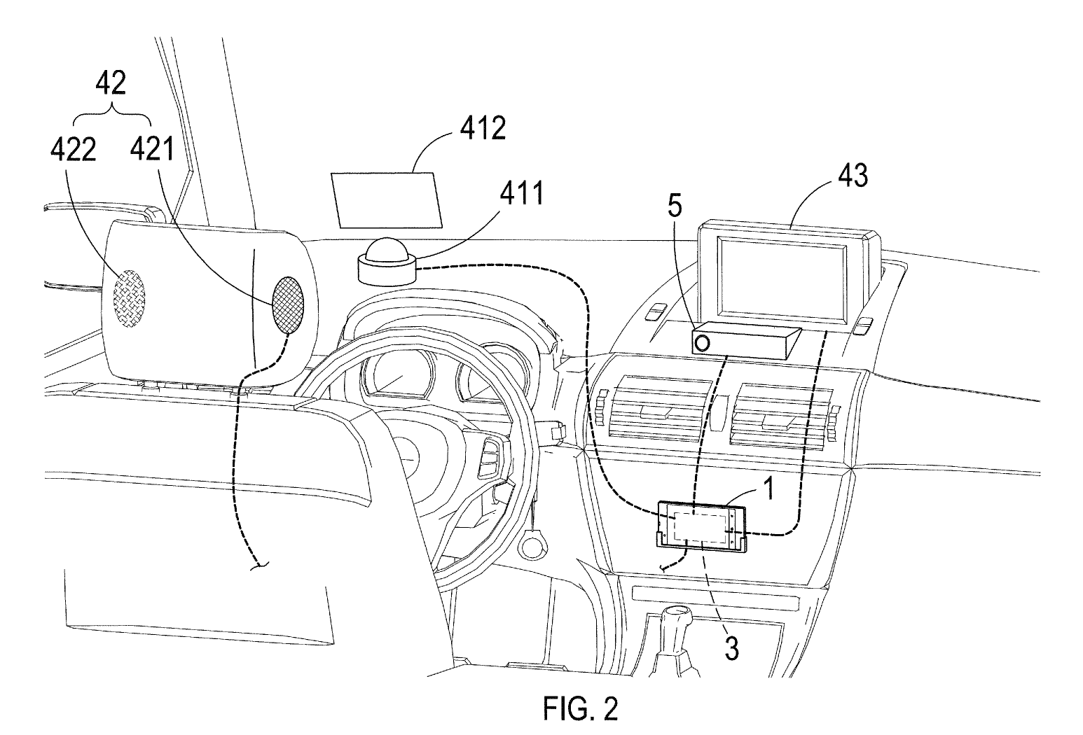

As shown in FIGS. 1 and 2, a motion sensing system for an automobile 6 contains an application module 2, a control device 3, an assistance subsystem 4, and a motion sensing device 5.

The application module 2 is installed in an information device 1 and is data-linked to the control device 3 in a wired or wireless manner. The information device 1 can be a smart phone, a tablet computer, or other mobile device capable of networking.

The assistance subsystem 4 is data-linked to the control device 3, and provides interaction with the driver of the automobile on behalf of the control device 3. The assistance subsystem 4 contains an image projection device 41, an audio control device 42, a recording device 43, and a wireless charging device 44. The image projection device 41 projects an image of the information device 1 for the driver to view. The audio control device 42 plays a piece of information provided by the information device 1 to the driver in an audible manner. The recording device 43 captures a video clip. The wireless charging device 44 charges the information device 1.

The recording device 43 contains a storage module 431 for storing video clips.

The projection device 41 contains a projection module 411 and a reflection patch 412. The projection module 411 projects the image onto the reflection patch 412 which is attached to an appropriate location on a wind shield of the automobile 6.

The audio control device 42 is configured inside a headrest of the driver in the automobile 6. The audio control device 42 contains an audio collection element 421 and a voice command definition module 422. The audio collection element 421 provides control to the control device 3 by voice commands uttered by the driver. The voice command definition module 422 allows the driver to define voice commands.

The motion sensing device 5 is data-linked to the control device 3, and provides control to the control device 3 by hand gestures performed by the driver. The motion sensing device 5 contains a gesture definition module 51 allowing the driver to define hand gestures.

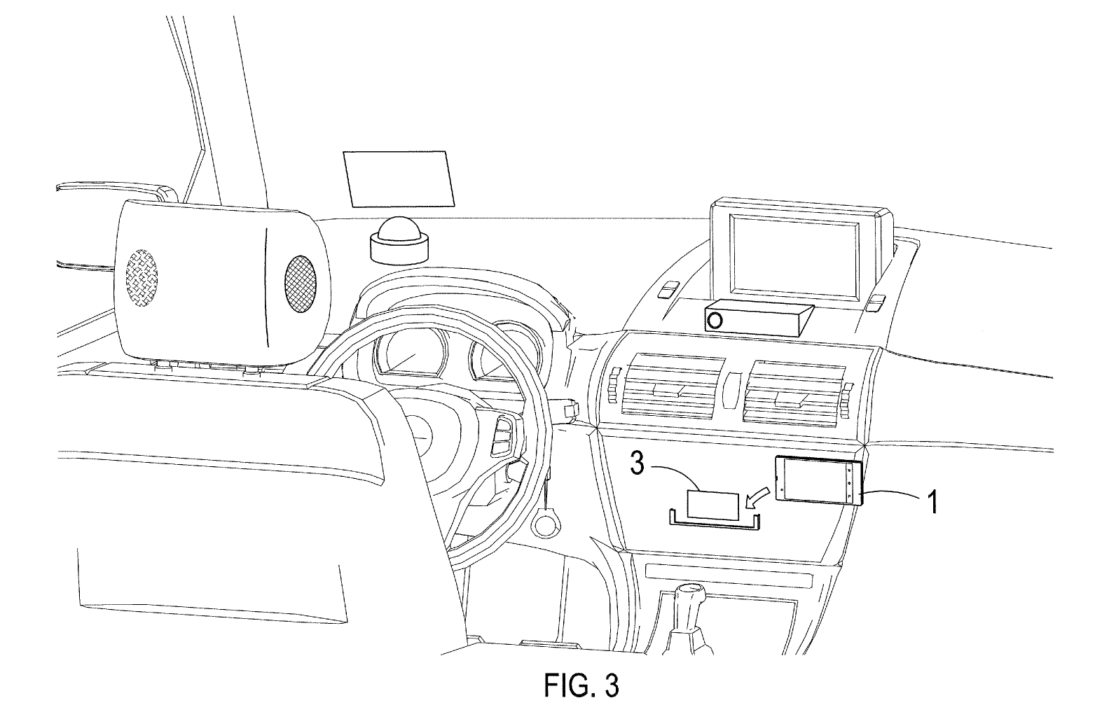

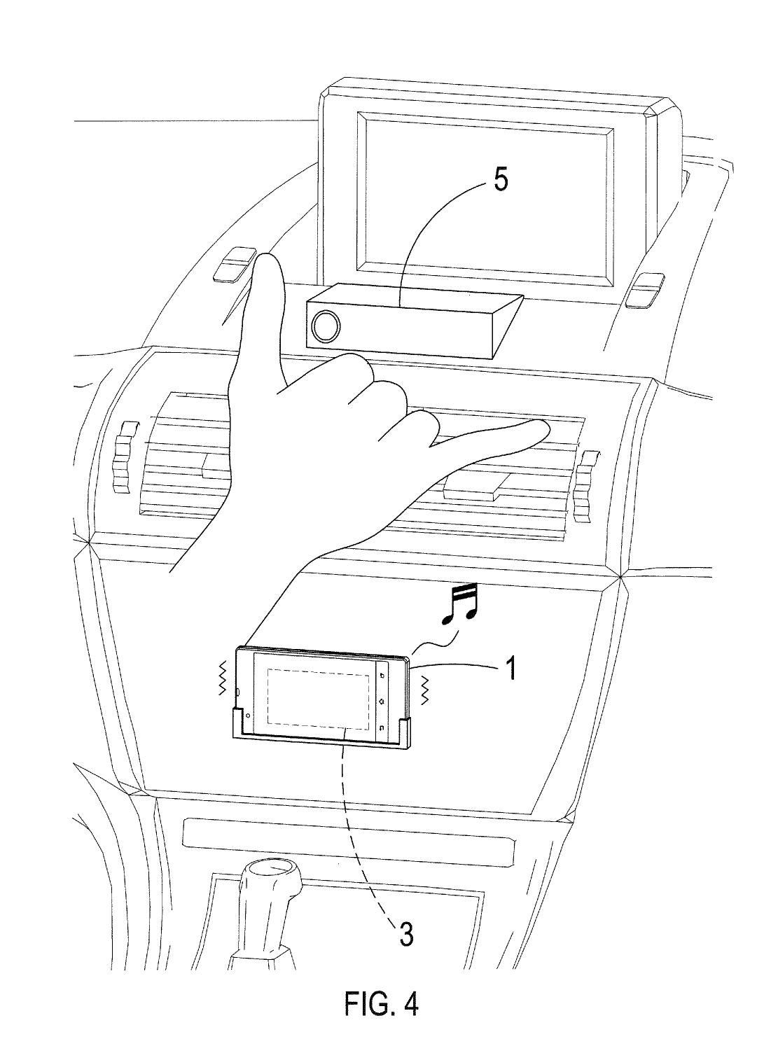

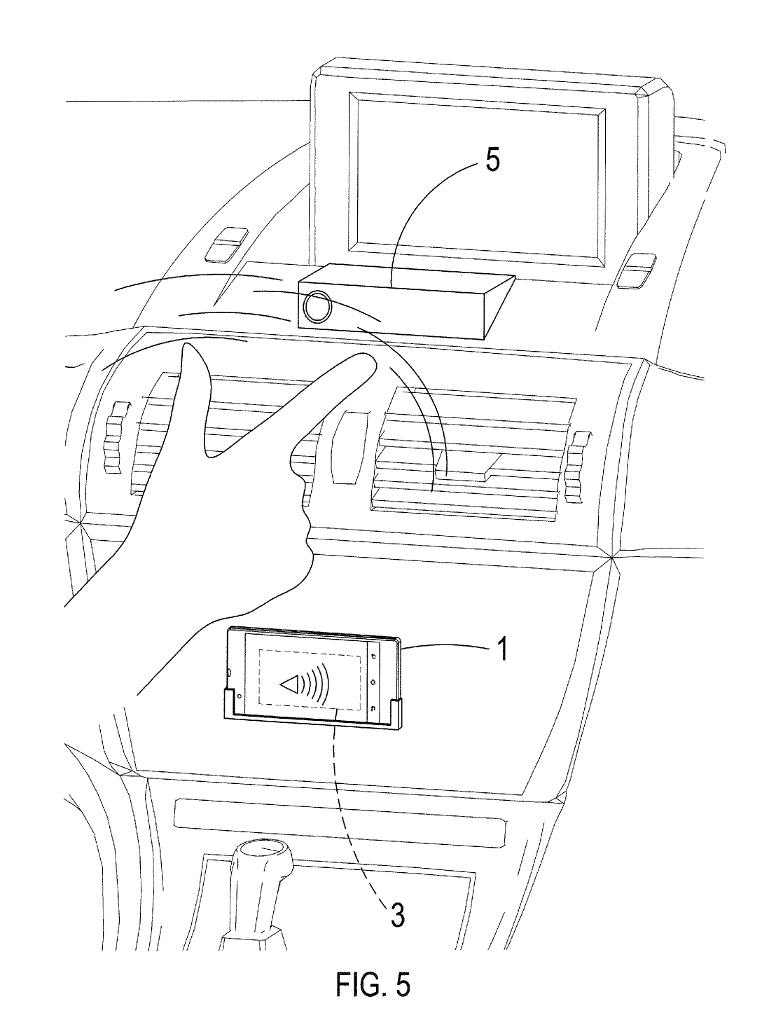

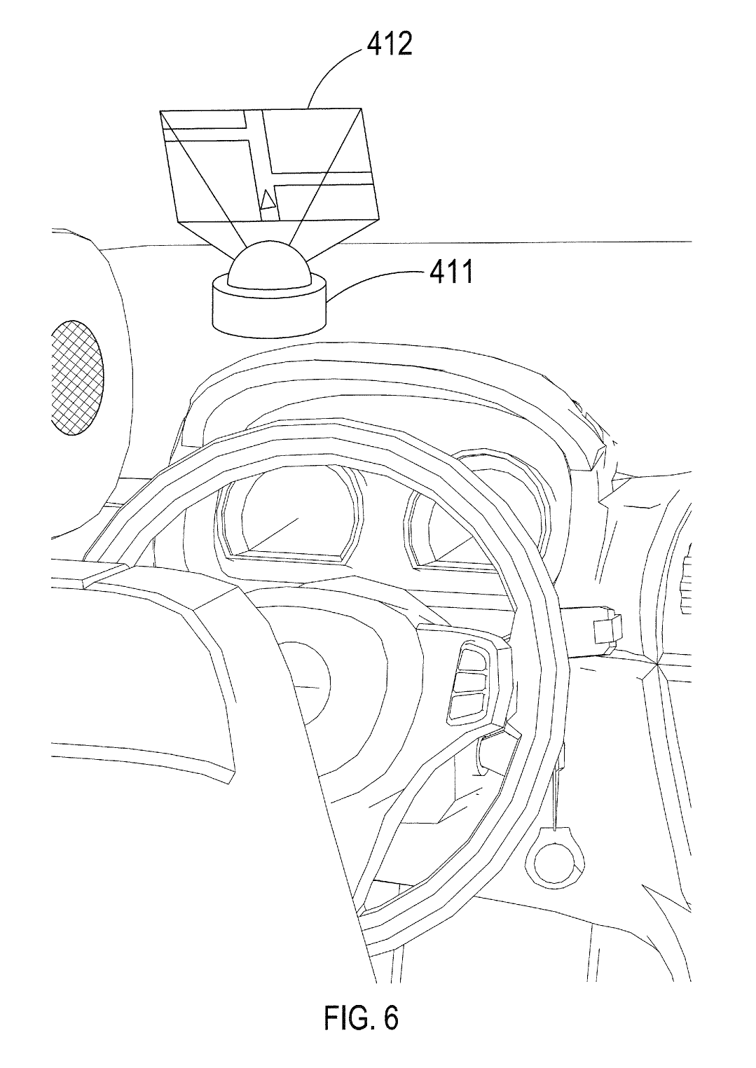

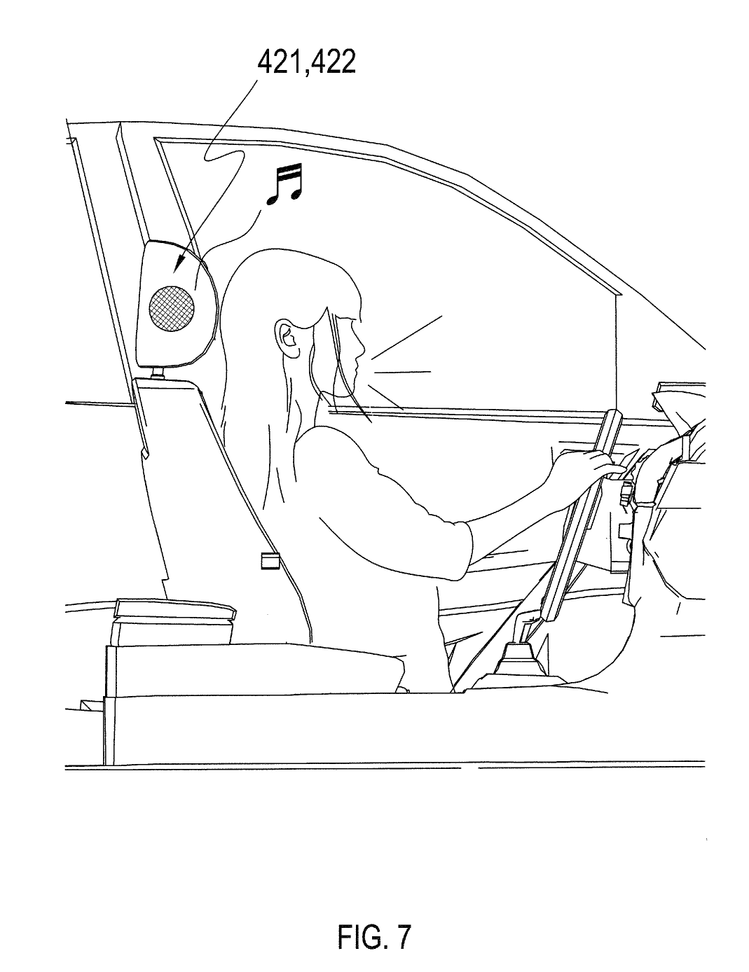

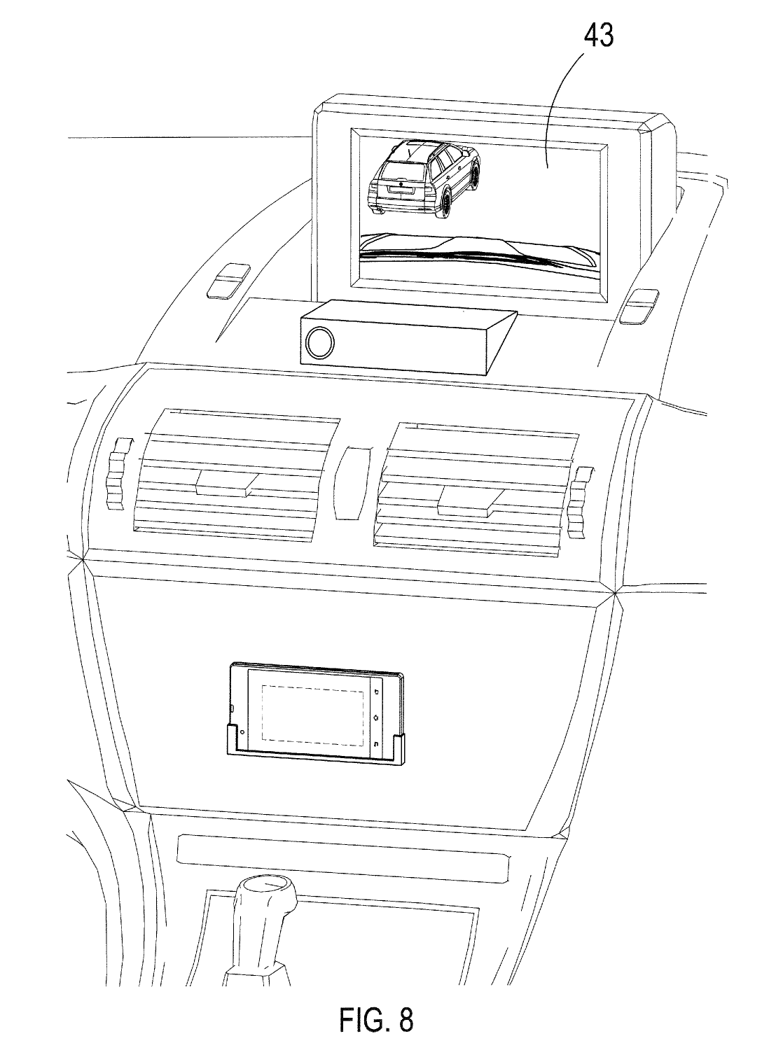

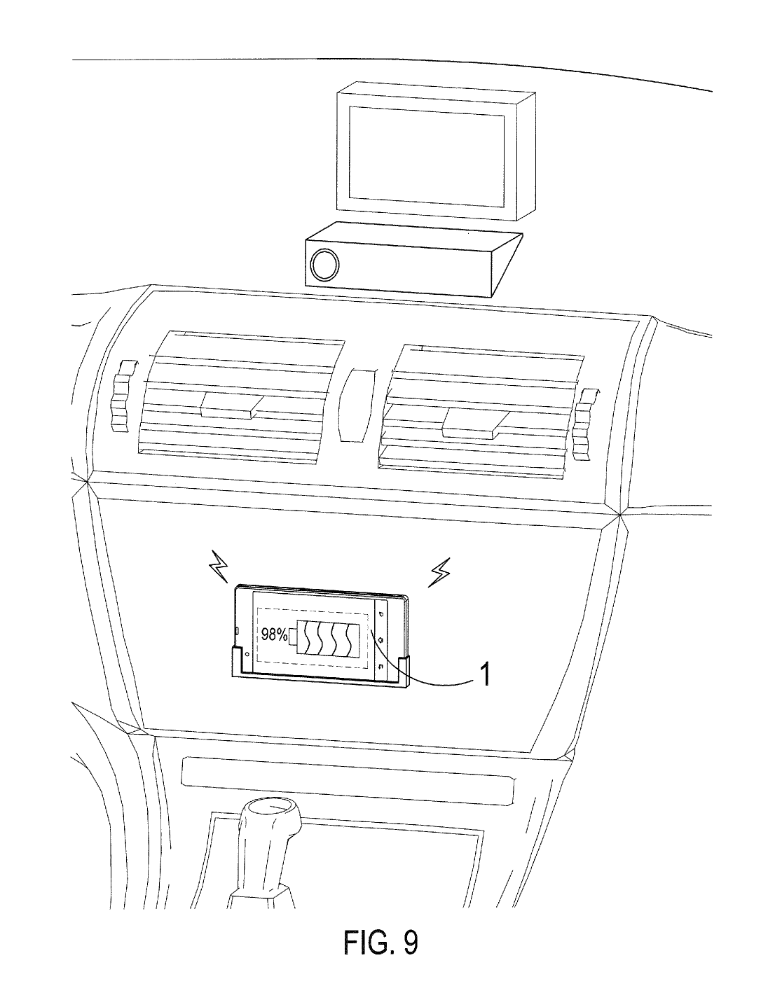

As further shown in FIGS. 3 to 9, the operation of the motion sensing system is described as follows. First, the application module 2 has to be installed and configured in the information device 1 and it is data-linked to the control device 3. In the present embodiment, the data link between the application module 2 and the support subsystem 3 is through NFC (Near Field Communication). The driver can define a number of hand gestures corresponding to control functions of the information device 1 and the automobile 6 by himself or herself using the motion sensing device 5 and the gesture definition module 51, or the driver can use some default hand gestures already defined in the motion sensing device 5. The driver then can wave his/her hand and make gestures within a coverage area by the motion sensing device 5 to operate the automobile 6 or the information device 1 with little distraction to the traffic condition ahead. For example, to answer an incoming call to the information device 1, the driver can define a hand gesture corresponding to the activation of an “answer call” function of the information device 1, and perform the hand gesture when the information device 1 rings. Similarly, another hand gesture can be defined to correspond to the activation of a “turn stereo on” function of the automobile 6. In addition to hand gestures, the driver can also use and define voice commands. New voice commands can be defined through the audio collection element 421 and the voice command definition module 422. The driver then utter default or self-defined voice commands so as to operate the automobile 6 or the information device 1. Similar to the hand gestures, voice commands can be defined to turn on, for example, the navigation system of the automobile 6 or the projection device 41. When the projection device 41 is activated, the projection module 411 projects the navigation image onto the reflection patch 412. In the meantime, the audio control device 42 provides voice announcement or reminder to the driver. Similarly, the recording device 43 can be activated through a hand gesture or a voice command. The recording device 43 captures clips of video for the traffic condition around the automobile 6. By some configuration in the control device 3, the video clips can be selectively stored in the information device 1 or in the storage module 431 for future assess. The wireless charging device 44 charges the information device 1 so that the information device 1 does not run out of electricity for working with the motion sensing system.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A motion sensing system for an automobile, comprising:
an application module installed in an information device;
a control device data-linked to the application module;
an assistance subsystem data-linked to the control device and providing interaction with a driver of the automobile on behalf of the control device; and
a motion sensing device data-linked to the control device and providing control to the automobile and the information device through the control device by hand gestures performed by the driver.

2. The motion sensing system according to claim 1, wherein the information device is one of a smart phone, a tablet computer, or other mobile device capable of networking; and the application module is data-linked to the control device in a wired or wireless manner.

3. The motion sensing system according to claim 1, wherein the assistance subsystem comprises an image projection device, an audio control device, a recording device, and a wireless charging device; the image projection device projects an image of the information device for the driver to view; the audio control device plays a piece of information provided by the information device to the driver in an audible manner; the recording device captures a video clip; and the wireless charging device charges the information device.

4. The motion sensing system according to claim 3, wherein the recording device comprises a storage module for storing video clips.

5. The motion sensing system according to claim 3, wherein the projection device comprises a projection module and a reflection patch; the projection module projects an image of the information device onto the reflection patch which is attached to an appropriate location on a wind shield of the automobile.

6. The motion sensing system according to claim 3, wherein the audio control device is configured inside a headrest of the driver in the automobile; the audio control device comprises an audio collection element and a voice command definition module; the audio collection element provides control to the control device by voice commands uttered by the driver; and the voice command definition module allows the driver to define voice commands corresponding to control functions of the information device and the automobile.

7. The motion sensing system according to claim 1, wherein the motion sensing device comprises a gesture definition module allowing the driver to define hand gestures corresponding to control functions of the information device and the automobile.

8. A motion sensing method for an automobile, comprising the steps of:
providing an application module in an information device, and a control device, a motion sensing device, and an assistance subsystem in an automobile;
data-linking the application module with the control device;
defining hand gestures corresponding to control functions of the automobile and the information device using the motion sensing device;
detecting the hand gestures of a driver of the automobile; and
performing the corresponding control functions through the control device and the application module on the automobile and the information device, respectively.

9. The motion sensing method according to claim 8, wherein the assistance subsystem comprises an image projection device, an audio control device, a recording device, and a wireless charging device; the image projection device projects an image of the information device for the driver to view; the audio control device plays a piece of information provided by the information device to the driver in an audible manner; the recording device captures a video clip; and the wireless charging device charges the information device.

10. The motion sensing method according to claim 9, wherein the audio control device is configured inside a headrest of the driver in the automobile; the audio control device comprises an audio collection element and a voice command definition module; the audio collection element provides control to the control device by voice commands uttered by the driver; and the voice command definition module allows the driver to define voice commands corresponding to control functions of the information device and the automobile.
